(19) United States
(12) Patent Application Publication
(10) Pub. No.: US 2009/0108032 A1
(43) Pub. Date: Apr. 30, 2009

(54) System, Method and Network for Distributing Beverages

(75) Inventor: Engbert Hermannes Pakkert, Delft (NL)

Correspondence Address: PEARNE & GORDON LLP, 1801 EAST 9TH STREET, SUITE 1200, CLEVELAND, OH, 44114-3108, US

(73) Assignee: Heineken Supply Chain B.V., Amsterdam (NL)

(21) Appl. No.: 11/925,364

(22) Filed: Oct. 26, 2007

(51) Int. Cl. B65D 83/00; B67D 5/62

(52) U.S. Cl. 222/394; 222/1; 222/399; 222/146.6; 222/396

(57) ABSTRACT

System for distributing beverage in containers, comprising at least one container and at least one tapping device for cooperation with said at least one container, wherein said at least one container is provided with a valve assembly, said containers containing beverage and a pressurising unit for pressurising said beverage in said container for dispensing said beverage through said valve assembly. A first spout assembly is provided for connecting to said valve assembly and comprising a lever for pressing said valve assembly for repeatedly opening and closing said valve assembly and an outlet pipe for expelling beverage from said container flowing through said valve assembly when in an open position. A second spout assembly comprises a connecting element for bringing and keeping said valve assembly in an open position, wherein an outlet element is connected to said connecting element with a first end and is provided with a fluid channel, wherein said outlet element is designed for cooperation with the tapping device for opening and closing said fluid channel.

### BACKGROUND TO THE INVENTION

1. Technical Field

The invention relates to a system for distributing beverages, especially distribution to consumers.

The invention further relates to a method for distributing beverages, especially distribution to consumers.

The invention moreover relates to a network for distributing beverages, especially distribution to consumers.

2. Background

Beverages such as beer or other carbonated beverages are commonly known to be distributed in bottles, cans or barrel shaped containers through outlet stores such as supermarkets. The beverage can be poured from the cans, bottles and other containers normally by gravity.

U.S. Pat. No. 6,360,923 discloses a beverage container for stand alone use. This container has to that end an internal pressure unit for pressurising the beverage inside said container, such that it can be dispelled through a beverage valve assembly and through a spout assembly having a spout extending to a position such that a glass or other such container can be held under an outlet end of said spout to be filled with said beverage.

U.S. Pat. No. 6,375,048 discloses a tapping system for beverages comprising a tapping device having a chamber in which a container can be suspended. The container comprises a hose connected to a valve assembly of the container with one end, and an opposite end that can be placed in a receiving space of the tapping device, after which a lid can be closed over said receiving space and said container. The container comprises a rigid outer container and a flexible inner container holding a beverage. The tapping device comprises a pump for pumping air between the inner and outer container, thus compressing the inner container to expel the beverage.

These known systems require different containers.

The disclosed system, method and network are designed to address the field of dispensing beverages.

### SUMMARY OF THE DISCLOSURE

In one aspect the disclosure is directed to a system for distributing beverage in containers which comprises at least one container and at least one tapping device for cooperation with the container. The container is provided with a dispensing valve assembly and contains beverage and a pressurising unit for pressurising the beverage in the container for dispensing the beverage through the valve assembly. A first spout assembly is provided for connecting to the valve assembly, which comprises a lever for pressing the valve assembly for repeatedly opening and closing the valve assembly. An outlet pipe is provided for expelling beverage from the container flowing through the valve assembly when in an open position. Furthermore a second spout assembly is provided comprising a connecting element for bringing and keeping the valve assembly in an open position, wherein an outlet element is connected to the connecting element with a first end. The outlet element is provided with a fluid channel, wherein said outlet element is designed for cooperation with the tapping device for opening and closing said fluid channel.

In another aspect the disclosure is directed to a method for distributing beverage, wherein beverage is comprised in at least one container. The container comprises a pressurising unit for pressurising beverage in said container. At least one first spout assembly is provided for said container for stand alone use of said container. At least one second spout assembly is provided for said container for use thereof with a tapping device.

In still another aspect the disclosure is directed to a distribution network for beverage. A first distribution channel is provided for beverage containers comprising beverage and a pressurising unit and at least one first spout assembly for stand alone use of said container. A second distribution channel is provided for distributing second spout assemblies for use of said container with a tapping device.

### BRIEF DISCUSSION OF THE DRAWINGS

FIG. 1 is schematically a perspective view of an assembly of a container with a spout assembly, in a dispensing device, partially in cross section;

FIG. 2 is schematically a perspective view of a container with a spout assembly for use in an assembly of FIG. 1;

FIG. 3 is schematically a perspective view of a container with another spout assembly for stand alone use;

FIG. 4 is schematically a perspective view of a container for use in an assembly according to FIG. 1 and in an assembly according to FIG. 3;

FIG. 5 is schematically a side view of a first spout assembly;

FIG. 6 is schematically a plan view of a number of second spout assemblies encased in a package;

FIG. 7 is schematically in cross sectional side view a container with a first spout assembly; and

FIG. 8 is schematically in cross sectional side view a container with a second spout assembly.

### DETAILED DESCRIPTION

In this description similar or identical parts have similar or identical reference numbers. Not all reference numbers are shown in all of the figures, even if similar or identical parts are shown. For the description of such parts reference can be made to the other figures.

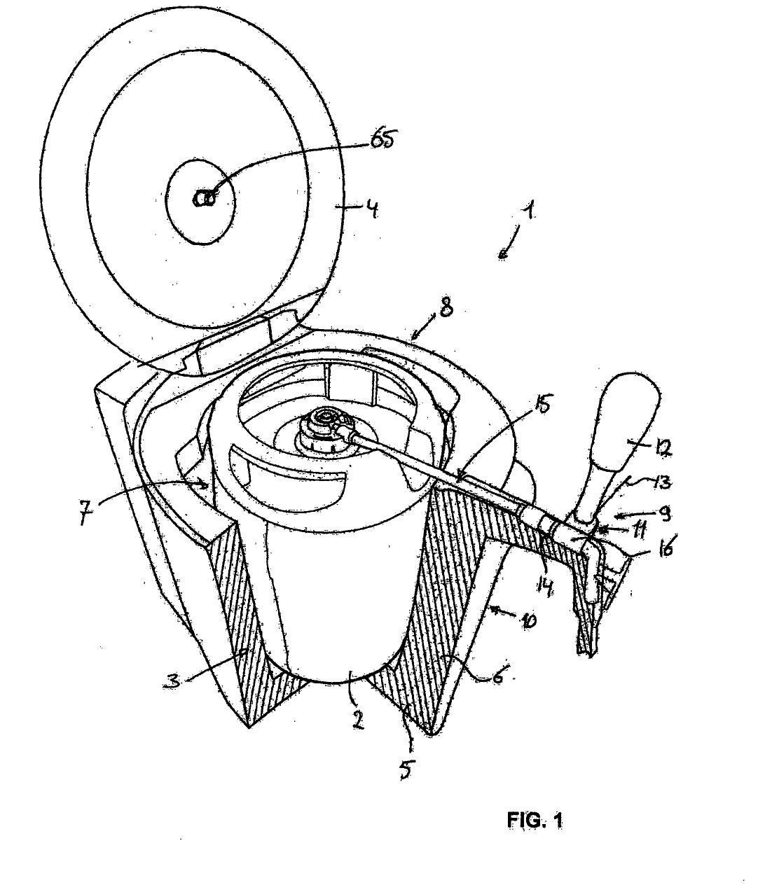

FIG. 1 shows in perspective view schematically a tapping device 1, partly broken away, and a container 2 inserted in said tapping device 1. Together they can form part of a first embodiment of a system for distributing beverage. A tapping device 1 of FIG. 1 comprises a lower housing part 3 and a lid 4. The lower housing part 3 comprises a bottom 5 and a wall 6, defining at least partly an inner space 7. The inner space 7 can for example be mainly cylindrical but can also have another shape. The lid 4 can cover an upper open side 8 of the inner space. A tapping assembly 9 can be provided, for example attached to the wall 6 or at least partly integrated with said wall 6. The tapping assembly can be provided near the opening 8, for example at an outer side 10 of said wall 6. The tapping assembly 9 can have an operating mechanism 11 for a valve of the container 2, to be discussed later. The operating mechanism can comprise a handle 12, attached to an axis 13 for allowing a rotational movement of the tapping handle around said axis 13.

The tapping assembly 10 can be provided with a lower channel part 14 for positioning a part of a spout assembly 15, which may be referred to as second spout assembly, and, if available, a valve 16 thereof. In an embodiment the lid 4 can comprise an upper channel part for enclosing said part of said second spout assembly 15 and, if present, said valve 16. In another embodiment a separate lid can be provided for covering such part of a second spout assembly 15 positioned in the lower channel part 14, to which end there can be provided an upper channel part in said separate lid.

In an embodiment a tapping assembly 10 can be as described in for example WO0192145 or EP1555240 in the name of the applicant, herein incorporated by reference.

In another embodiment a tapping assembly 10 can be provided which allows manual manipulation of a valve 16 of the second spout assembly 15 directly, for example by having the valve 16 or part thereof sticking out from the tapping device. Then the valve or part thereof can be understood as forming the tapping assembly 9 or part thereof.

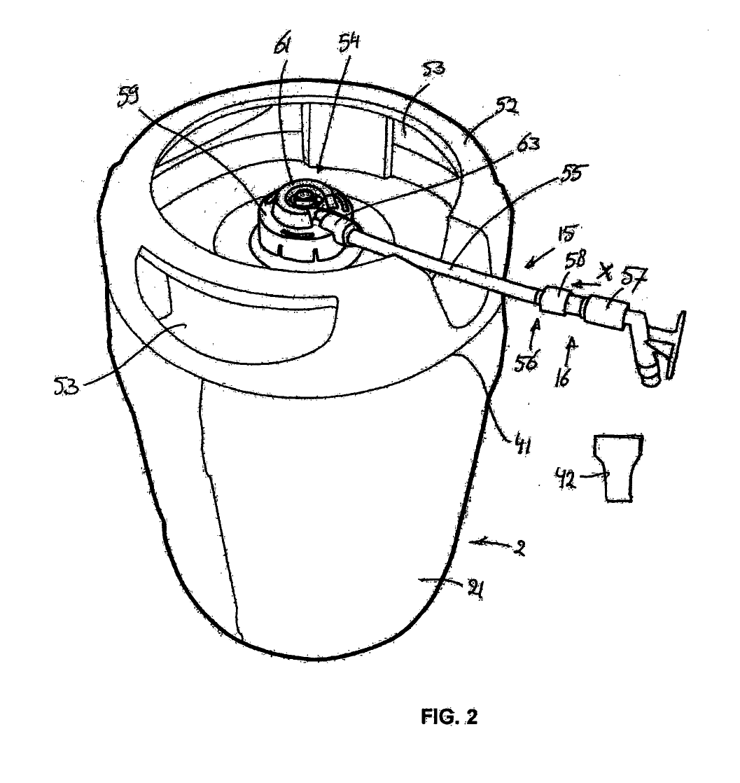

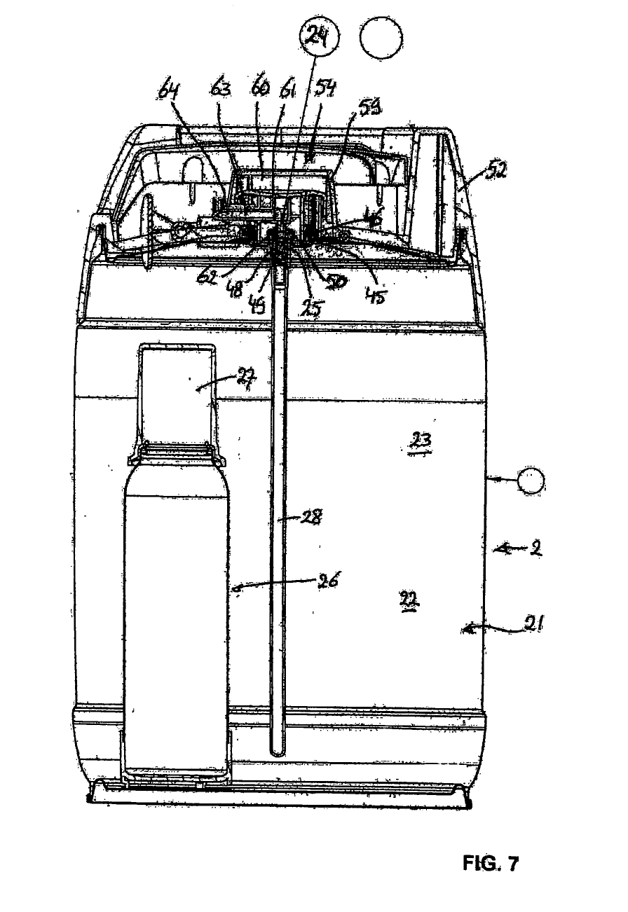

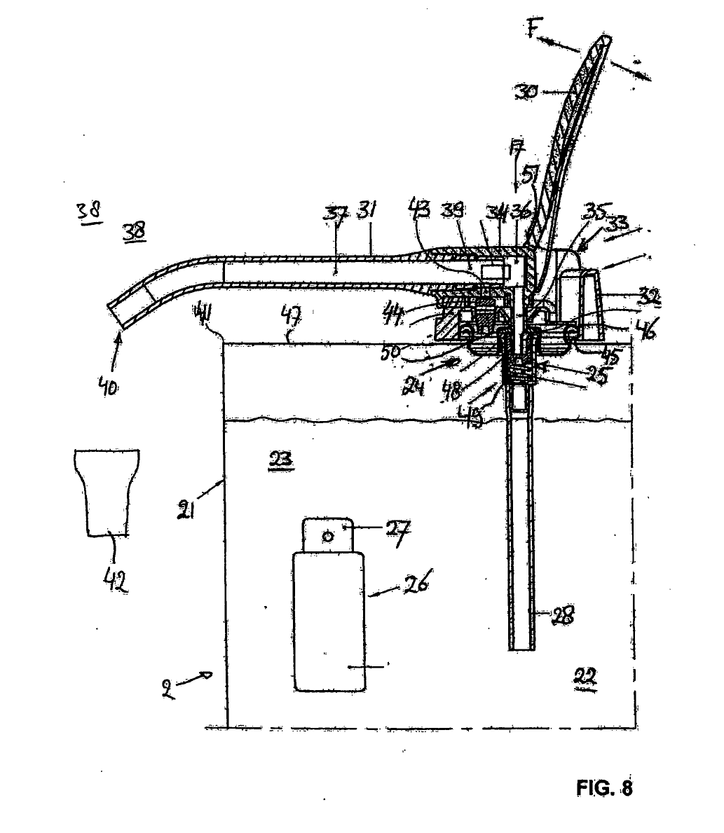

In FIG. 2-4, 7 and 8 exemplary embodiments of a container 2 are shown, schematically, in FIGS. 7 and 8 partly broken away. The container 2 comprises a body 21, which can for example be made of plastic of metal of combinations thereof. Within the body 21 a space 22 is provided for containing a liquid 23, more specifically a beverage such as beer, soft drink, wine or the like. In an embodiment the liquid 23 can be a carbonated beverage such as beer. The container 2 may be provided with a valve assembly 24 which can be formed by a valve 25 or a combination of elements, comprising a valve 25. A pressure regulator 26 may be provided in or on the container 2, for pressurising the liquid 23 within the space. In an embodiment the pressure regulator 26 can be provided inside the space, and can be submerged at least partly in the liquid 23. In an embodiment the pressure regulator 26 can contain CO₂, which can be dosed as a gas into the space 22 by a regulator 27, based on the pressure within the space, in order to maintain a pressure within the space 22 which may be approximately equal to an equilibrium pressure of the liquid, especially a CO₂ containing beverage. In such embodiment the CO₂ content of the beverage can be maintained. In the embodiments shown the pressure regulator 27 is only shown in outline. For embodiments of such regulator reference is made to for example U.S. Pat. No. 6,360,923 or WO02/42197, incorporated herein by reference. A riser pipe 28 can be provided within said container 2, for leading the beverage 23 towards the valve assembly 24.

A container 2 can in an embodiment be as described in for example PCT/NL99/00144 in the name of the applicant, herein incorporated by reference. The container 2 can in another embodiment be as described in NL1031412, in the name of the applicant, incorporated herein by reference. In still a further embodiment the container 2 can be according to any one of NL1032890, NL1032892 or NL1032893, in the name of the applicant, incorporated herein by reference.

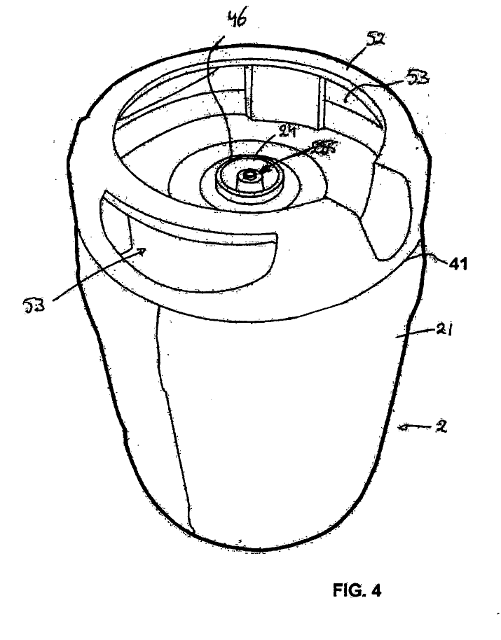

In an embodiment a tapping device 1 can be designed like a drink dispenser as disclosed in PCT/NL99/00454 in the name of the applicant, herein incorporated by reference. In such tapping device 1 a pump can be incorporated for pressurising a beverage in the container. In such embodiment one embodiment of the container can be a bag-in-container type container. In another embodiment the container can be as described with respect to FIG. 4.

In another embodiment a tapping device 1 can be designed without a pump. In such embodiment the tapping device 1 can be further designed as described in PCT/NL99/00454 in the name of the applicant, herein incorporated by reference, that is without the pump and parts associated therewith, such as a channel for leading air from a pump into the container.

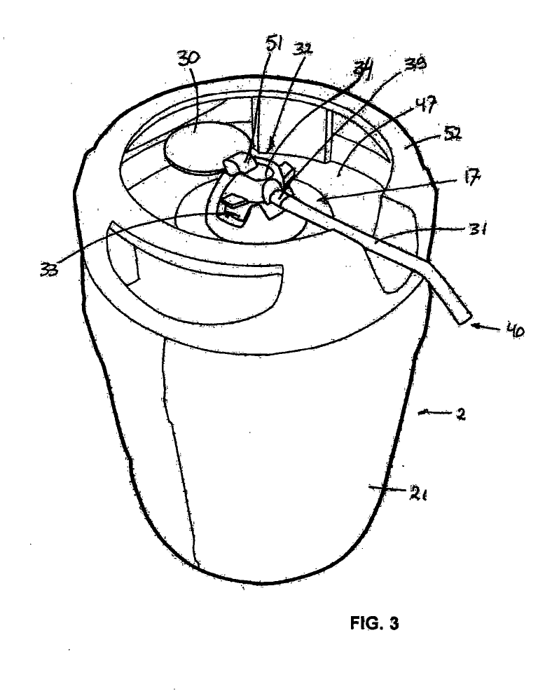

In FIG. 4 a container 2 is shown without a first spout assembly 17 or second spout assembly 15. In FIGS. 1, 2 and 7 the container 2 is shown with a second spout assembly 15, in FIGS. 3 and 8 with a first spout assembly 17. From these figures it may be clear that the same container can be used with both spout assemblies 15, 17.

A first spout assembly 17 of which embodiments are shown by way of example in FIGS. 3 and 8, comprises a lever 30 for pressing the valve 25 of the valve assembly 24 repeatedly between an open and a closed position, and an outlet pipe 31 for expelling beverage 23 from the container. The first spout assembly 17 can have a housing part 32 that can be attached to the container 2, such that it extends at least partly above and around the valve 25 of the valve assembly 24 of the container 2. The housing part 32 can for example be substantially ring shaped, defining an inner space 33. A movable connecting part 34 is provided, extending at least partly within the inner space 33, which connecting part 34 has a first leg 35 for fluid connection to the valve 25 and a second leg 36 for fluid connection to the pipe 31. A channel 37 extends through said legs 35, 36 and through said pipe 31, for fluid connection between the inner space 22 of the container 2 and the environment 38 of the container 2 when the valve 25 is opened. The pipe 31 can in an embodiment extend with a first end 39 into the connecting part 34 and the opposite end 40 can be bent down slightly with a part extending outside the circumferential edge 41 of the upper side of a container 2, such that for example a glass 42 can be held under said second end 40, for dispensing beverage into said glass 42. For the sake of convenience the glass 42 is not shown in scale.

Near the first end 39 an opening 43 can be provided at the lower side of the pipe 31. A resilient cushion 44 can be provided below the opening 43, for closing the opening 43 when the pipe 31 is pressed down in the direction of the container, when opening the valve 25, whereas the opening 43 can be open when the pipe is brought back to an upper position when the valve 25 is closed. The opening 43 can thus reduce dripping when the valve 25 is closed.

In an embodiment the housing part 23 can be connected to the container 2 by forcing clamping elements 45 such as resilient fingers under an edge of a folding part 46 with which the valve assembly 24 can be attached to the container 2, for example in an opening in the top 47 of the container 2. The valve 25 or valve assembly 24 can be any type. In the embodiments shown the valve assembly 24 is of an aerosol type, which in an embodiment can have a valve body 48 forced by a spring 49 against a seat 50. The first leg 35 of the connecting part 34 can be forced against the valve body 48, pushing it down against the spring 49 for allowing beverage to pass into the channel 37. The connecting element 34 can be pushed down by moving the lever 30, in for example a forward direction F, such that an edge 51 of the lever 30 will push against the connecting part 34. When the lever 30 is released, the spring 49 will force the connecting part 34 back up, closing the valve 25 and bringing the lever 30 back towards an initial position.

In an embodiment of the container 2 with the first spout assembly 17, such as for example shown in FIG. 8, the container 2 can be used for stand alone. This is to be understood as encompassing but not limited to use in which the container 2 can be used for dispensing beverage 23 from the inner space 22 by moving the lever 30 as discussed above. In an embodiment the container 2 can be provided to a consumer with a first spout assembly 17 attached to the container, with the lever 30 moved fully backward, to a position substantially parallel to the top of the container 2, as is shown in FIG. 3. In this position the lever 30 can not operate the valve assembly 24. This is especially advantageous when a top ring 52 is provided extending from the top of the container 2. Such top ring 52 can for example protect the spout assembly 17 and/or the top of the container 2 and/or can be provided with openings 53 for gripping the container 2.

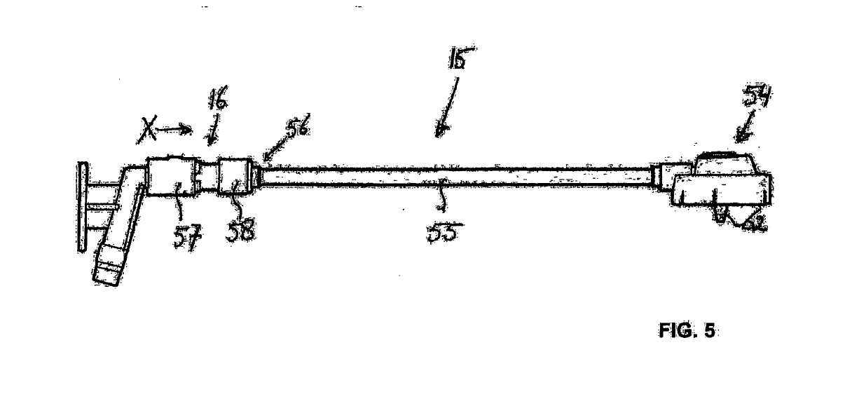

A second spout assembly 15 as shown in FIGS. 1, 2, 5, 6 and 7, can comprise a connecting element 54 and an outlet element 55 connected to the connecting element 54. The outlet element 55 can be at least partly flexible. In an embodiment the outlet element 55 may comprise a flexible tube having a length. The length can be greater than half a cross section of the container 2, such that an end 56, distanced from the connecting element 54 can extend outside the circumferential edge 41 of the container 2. In an embodiment a valve 16 can be connected to the end 56 which can be placed in and cooperate with the tapping assembly 9, as discussed above. In an embodiment as shown in FIG. 2 the valve 16 can be of an in-line valve type, such that when a first housing part 57 is forced in a direction X relative to a second housing part 58 the valve is opened, whereas when it is forced in the opposite direction it may be closed. This forcing can be obtained by the operating mechanism 11, through manipulation of the handle 12. Such is e.g. known from WO0192145 or EP1555240, incorporated herein by reference.

The connecting element 54 can comprise a housing part 59, which can for example be ring shaped with an inner space 60, similar to the housing part 32, which can be attached to the container near the valve assembly 24, again similar or identically to the housing part 32 of the first spout assembly 17. A connecting part 61 is provided extending at least partly inside the inner space 60. The connecting part 61 has a first leg 62 for fluid connection with the valve 25 and for pressing down the valve body 48 against the spring 49, and a second leg 63 to which the outlet element 55 is connected, in fluid communication. A channel 64 extends through the first and second leg 62, 63 and the outlet element 55, for bringing beverage 23 from the inner space 22 to the end 56 and, if provided, the valve 16.

In a first position the connecting part 61 can be positioned in an upper position relative to the housing part 59, such that the first leg 62 extends not or only partly into the valve body 48, which rests against the seat 50, closing off the valve 25. The connecting part 61 can be pushed down into a second position, shown in FIG. 7, in which the valve body 48 is pushed away from the seat 50 and the valve 25 is open, allowing beverage to pass into the channel 64.

As can be seen in FIG. 1, the container 2 can be positioned in the inner space 7 of the tapping device 1, with the valve 16 positioned in the tapping assembly 9. The valve assembly 24 is accessible from the opening 8. In an embodiment the lid 4 can have a protrusion 65. When the lid 4 is closed over the opening 8 and the inner space 7, enclosing the container 2 inside the inner space 7, this protrusion 65 can be forced against the connecting part 61, forcing this from the first position into the second position. Then beverage can be dispensed from the container 2 by operating the tapping mechanism 11 of the tapping assembly 9, by manipulating the handle 12 or, in an other embodiment, by operating the valve 16 by hand or another mechanism. In another embodiment the connecting 61 part and the housing part 59 can be provided with blocking elements that can block the connecting part 61 at least in the second position, relative to the housing part 59. In such embodiment a consumer can push the connecting element 61 from the first into the second position, for example manually, before closing the lid 4 over the space 7 and the container 2. A connecting part 61 can keep the valve 25 open, such that only the tapping assembly 9 has to be used for dispensing beverage. Again, a glass 42 or such can be held below an outlet side 66 of the valve 16 or end 56 for dispensing the beverage therein.

In an alternative embodiment of the second spout assembly 15, the connecting part 61 and the housing part 59 can be integrated into a single part connecting element 54, wherein by forcing the connecting element 54 onto the valve assembly 24, for example using clamping elements 45 clamping under the fold 46, the valve 25 is opened and kept opened. This can be accomplished by hand or by using the lid 4.

The tapping device 1 can be provided with a cooling assembly, such as for example but not limited to Peltier cooling, for cooling a container 2 inside the inner space 7.

A container 2 can be provided to a consumer with at least one first spout assembly 17, at least one second assembly 15 or a combination of at least one first spout assembly 17 and at least one second spout assembly 15. The latter will allow the consumer to choose between stand alone use and use with the tapping device 1.

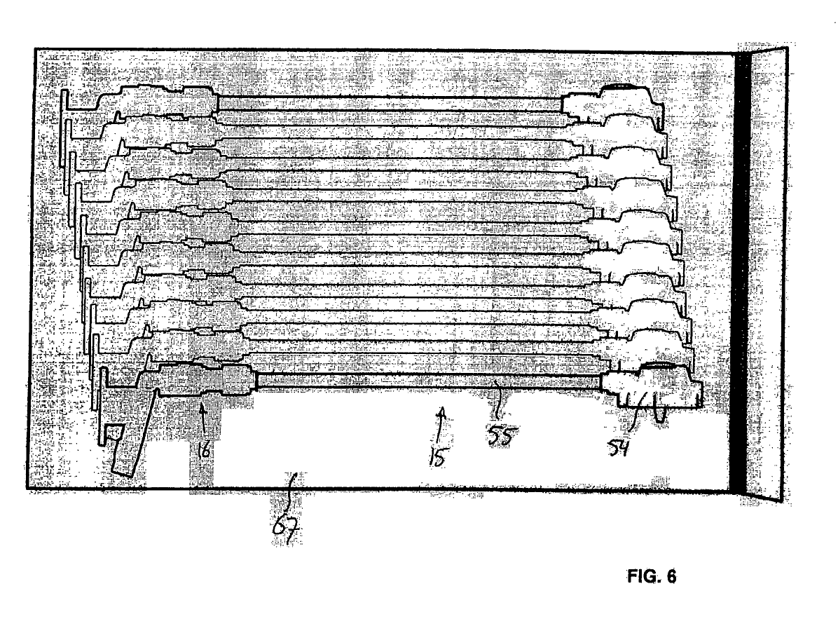

Alternatively a consumer can purchase a tapping device 1 together with at least one second spout assembly 15. This second spout assembly may be provided within the inner space 7 or in any other suitable way. Preferably a consumer will get a larger number of second spout assemblies 15 with the purchase of a tapping device 1. In FIG. 6 for example a package 67 containing ten such second spout assemblies 15 is shown, which can for example be a plastic bag, a pouch, a box or any other suitable package. This may be provided with the purchase of a tapping device 1. A consumer can then obtain a container 2, with a first spout assembly 17. The consumer can then decide to use the container 2 as stand alone, with the first spout assembly 17, or can decide to use the container with a tapping device 2, by discarding the first spout assembly 17 and attaching a second spout assembly 15 to the container 2.

After having used a number of containers 2 such that all second spout assemblies have been used, or nearly all, in an embodiment of a system according to the description a consumer can obtain a new number of second spout assemblies 15, for example again a package of ten, such as but not limited to the package of FIG. 6. In an embodiment these second spout assemblies can be ordered through a channel different than the channel through which the tapping device has been obtained. Such channel can for example include the Internet. An Internet site address or a personal code or the like identifier such as a PIN code can be provided on or with the tapping device 1, which can provide access to an Internet site on which the consumer can order new second spout assemblies. In an embodiment the spout assemblies 15 can be sent to the consumer by mail or courier. In an embodiment the consumer can also order containers through the same channel and/or different channels. The code can prevent unauthorised persons to obtain second spout assemblies, which in an embodiment can be offered for free or a low price.

In an embodiment a tapping device and/or containers can be distributed through a first sales and/or distribution channel, for example retail, such as mall's, shopping centres, shops, mail order or the like. Spout assemblies can then be purchased or obtained through a second channel, such as a web based channel.

For a distributor the Internet site may provide information about the number of containers that is used with a second spout assembly, such that he can e.g. define, redefine or assess his marketing strategy on the bases thereof. It should be clear that also first spout assemblies 17 could be distributed through a web based channel, for example the said web site, together with, separate of or in stead of the second spout assemblies.

The invention is by no means limited to the or any embodiments shown and described herein, by way of example. Different embodiments are possible falling within the scope of the claims. For example the pressure regulator 26 can be positioned partly or entirely outside the container or at least outside the inner space 22. The first and second spout assembly could be using the same housing part connected to the container, with the connecting parts being exchangeable. The containers can have different sizes and shapes. The tapping device can be made differently, for example for front- or back-loading, side loading or bottom loading of the container. The valve assembly 24 can be provided in a different surface of the container 2, for example in the wall of the body 21. The valve 16 can be different type, for example a ball type valve, a squeeze type valve or the like. Other actuators can be provided for moving the connecting element of the first spout assembly for repeatedly opening and closing of the valve assembly of the container.

These and other amendments, including any combination of features of the embodiments shown and/or described are considered disclosed, including combinations with features of embodiments shown in the documents included herein by reference, falling within the claims

1. System for distributing beverage in containers, comprising at least one container and at least one tapping device for cooperation with said at least one container, wherein said at least one container is provided with a valve assembly, said containers containing beverage and a pressurising unit for pressurising said beverage in said container for dispensing said beverage through said valve assembly, wherein a first spout assembly is provided for connecting to said valve assembly, said first spout assembly comprising a lever for pressing said valve assembly for repeatedly opening and closing said valve assembly and an outlet pipe for expelling beverage from said container flowing through said valve assembly when in an open position and a second spout assembly comprising a connecting element for bringing and keeping said valve assembly in an open position, wherein an outlet element is connected to said connecting element with a first end and is provided with a fluid channel, wherein said outlet element is designed for cooperation with the tapping device for opening and closing said fluid channel.

2. System according to claim 1, wherein said second spout assembly comprises a valve connected to said outlet element for cooperating with a tapping assembly of said tapping device, such that said valve can be opened and closed by said tapping assembly.

3. System according to claim 1, wherein said tapping device comprises a cooling space for holding said container.

4. System according to claim 2, wherein said outlet element of said second spout assembly comprises a flexible portion between said connecting element and said valve, wherein said tapping device comprises a receiving space for said valve in a position in which an outlet side of said valve is directed such that a glass of tumbler can be positioned below said outlet end.

5. System according to claim 1, wherein said pressurising unit is provided inside said container and is self regulating for maintaining during use the pressure within said container at a predetermined level.

6. Method for distributing beverage, wherein beverage is comprised in at least one container, said container comprising a pressurising unit for pressurising beverage in said container, wherein at least one first spout assembly is provided for said container for stand alone use of said container and at least one second spout assembly is provided for said container for use thereof with a tapping device.

7. Method according to claim 6, wherein said container is sold to a customer with at least one first spout assembly and at least one second spout assembly.

8. Method according to claim 6, wherein at least second spout assemblies are distributed separate from said containers.

9. Method according to claim 8, wherein second spout assemblies are distributed through a web based channel.

10. Method according to claim 6, wherein a code is provided with said tapping device or with a container, wherein with said code at least one or a number of second spout assemblies can be purchased through a dedicated channel.

11. Method according to claim 6, wherein at least one second spout assembly is provided in or with a tapping device when sold to a customer.

12. Distribution network for beverage, wherein a first distribution channel is provided for beverage containers comprising beverage and a pressurising unit and at least one first spout assembly for stand alone use of said container, wherein a second distribution channel is provided for distributing second spout assemblies for use of said container with a tapping device.

13. Distribution network according to claim 12, wherein said first distribution channel comprises retail premises, wherein said second channel is web site orientated.

14. Distribution network according to claim 12, wherein a distribution channel is provided for distributing said tapping device, wherein at least one second spout assembly is distributed with said tapping device.

15. Distribution network according to claim 14, wherein said distribution channel comprises at least one of said first and said second distribution channel.

16. Assembly of a container, a first spout assembly and a second spout assembly, the first and second spout assembly having a coupling for coupling with a valve assembly of the container.

17. Method for providing beverages to consumers, wherein a consumer obtains a beverage tapping device in which a beverage container can be inserted, wherein the consumer obtains with the tapping device a number of spout assemblies for connecting in subsequent order a number of individual containers obtained by the consumer to the tapping device, wherein at least a number of said containers is self propelling and is provided with a different spout assembly for stand alone use of the container.

18. Method according to claim 17, wherein the consumer obtains through a distribution channel a further number of said spout assemblies for connecting a container to the tapping device.

19. Method according to claim 18, wherein the distribution channel includes the Internet.

20. Method according to claim 17, wherein the consumer dispenses a spout assembly with a container with it has been used after that container is emptied to a desired degree.
